(19) United States
(12) Patent Application Publication
(10) Pub. No.: US 2014/0310094 A1
(43) Pub. Date: Oct. 16, 2014

(54) ADVERTISING OPTIMIZATION FOR MOBILE TELEPHONY

(71) Applicant: MASSIVE IMPACT INTERNATIONAL LIMITED, KOWLOON (HK)

(72) Inventors: SEPHI SHAPIRA, TEL-AVIV, IL (US); MOSHE SHACHAR, TEL-MOND (IL)

(73) Assignee: MASSIVE IMPACT INTERNATIONAL LIMITED, KOWLOON (HK)

(21) Appl. No.: 14/248,454

(22) Filed: Apr. 9, 2014

Related U.S. Application Data
(60) Provisional application No. 61/810,717, filed on Apr. 11, 2013.

(51) Int. Cl. G06Q 30/02

(52) U.S. Cl. CPC G06Q 30/0244; G06Q 30/0275
USPC 705/14.45

(57) ABSTRACT

A bidding system on a network between suppliers of advertising space in web content for mobile telephones on the one hand, and advertisers on the other hand, to supply advertising space with advertisements included therein to mobile phone users at content download time, bidding being carried out per content page per user download. The bidding system operates by determining real time sales related to a given advertisement campaign; determining a proportion of those real time sales to be applied to the advertising space currently being downloaded; presenting the proportions as bids; selecting a best bid; and allowing the advertisement campaign corresponding to the selected bid to use the advertising space currently being downloaded. The publisher who is providing the advertising slot may continue to be paid on a per click basis.

### RELATED APPLICATION

This application claims the benefit of priority under 35 USC 119(e) of U.S. Provisional Patent Application No. 61/810,717 filed Apr. 11, 2013, the contents of which are incorporated herein by reference in their entirety.

### FIELD AND BACKGROUND OF THE INVENTION

The present invention, in some embodiments thereof, relates to advertising optimization for mobile telephony.

There are currently three business models which are available to advertisers who are trying to profitably retail their products over mobile advertising infrastructure. All three business models are based on bids for impressions, clicks or predefined events and their predefined value (e.g. an actually sale or a lead generated). The current models in the market are:

Ad network business model;

affiliate network business model; and

exchange business model.

Ad networks and exchanges use bidding in real time or in batch to enable advertisers to compete for clicks on advertisements inserted into mobile traffic inventory. The ad network and exchange models require the advertiser to calculate the conversion rate from a click to an actual sales event and to constantly and in most cases manually optimize the campaign parameters including bid and targeting (e.g. device type, key words, mobile operators, content type etc.) to ensure his profit margins are maintained.

Partially addressing this challenge to maintain profit margins on ad spend are affiliate networks. Affiliate networks predefine a fixed cost per advertiser measured event including an actual sale, a lead or any other event which can be measured and reported by the advertiser. While this reduces the operational effort of the advertiser to guarantee a profit on advertising spend, this service does not automatically calculate the variations in advertisement income for the publisher, nor does it enable real time automatic optimization based on the most updated advertiser income metric. In the affiliate model, the advertiser needs to constantly measure his real income from advertising spends.

Moreover, while the affiliate networks have been well established in the online world the affiliate model has not been adopted by the mobile community. The main reason is lack of ROI from mobile advertising which, according to several researchers, is the biggest deterrent for marketers. A study which was published during the past year by The Relevancy Group reveals that 73% of the advertisers stated that improving ROI for mobile campaigns is their top priority. In addition survey results show that:

(1) marketers are dissatisfied with click-based mobile advertising (56 percent of Fortune 500 marketers are dissatisfied with or don't use click-based mobile advertising); and

(2) the most effective mobile ad campaigns are those where they pay for signups.

It is clear that the well-known and very successful online advertising models simply do not work in the mobile world. While in the online world the context is quite stable (desktops, laptops located in the office or at home), the immediate mobile context is completely different. The user can be found at home or outside traveling, in a car or in the middle of shopping. Many of the mobile campaigns have negative ROI simply because of their low relevancy to the user's immediate context. Thus advertising of vacuum cleaners in not relevant for a user who is in the middle of jogging. Nevertheless, targeted and context based advertising with highly optimized campaigns can be very successful. Combining these insights suggests that the mobile environment is a completely different landscape from the online market and a new model which contains the best of all worlds is required.

### SUMMARY OF THE INVENTION

The present embodiments provide a solution which may be real time, performance based, and optimized to remove risk from the advertiser. Advertising slots become available as users download content, and the various advertisers bid for the slots. Actual sales generated from already inserted advertisements provide a way of attaching a value to an advertisement to be placed, and then a bid can be made for the advertising space using that value. Since the bid is based on actual sales data, the risk to the advertiser is reduced.

According to an aspect of some embodiments of the present invention there is provided a bidding system on a network between suppliers of advertising space in web content for mobile telephones on the one hand, and advertisers on the other hand, to supply advertising space with advertisements included therein to mobile phone users at content download time, the advertising space to be supplied on a best bid basis at the content download time: the system electronically mediating a method as follows:

for each advertiser determining real time sales related to a given advertisement campaign;

for each advertiser determining a proportion of the real time sales to relate to the advertising space currently being downloaded;

presenting the proportions as bids by respective advertisers to allow their respective advertisement campaign to use the advertising space at the currently downloading mobile user;

selecting one of the bids as a best bid; and

allowing the advertisement campaign corresponding to the selected bid to use the advertising space at the currently downloading mobile user.

In an embodiment, the proportion is adjusted for available data of a currently downloading mobile user.

In an embodiment, the selecting of the best bid comprises applying a total budget constraint to each advertiser to limit a total number of bids won in a predetermined time frame.

In an embodiment, a total budget for the total budget constraint is less by a factor than a total budget indicated by a corresponding advertiser.

In an embodiment, a total budget for the total budget constraint is dynamically adjusted based on changes in the real time sales.

In an embodiment, the selecting of the best bid comprises finding highest bids in order, and placing as the best bid the highest bid indicating a positive return on investment.

An embodiment may involve, after placing the bid, checking whether the total bids of the corresponding advertiser have reached the total budget constraint, and if the total bids exceed the total budget constraint then removing the corresponding advertiser from an active campaigns list for participating in following bids.

An embodiment may comprise providing to the advertiser a cost per action model for placing advertisements and providing to the suppliers a cost per click model for selling advertising space.

An embodiment may comprise factoring a projected number of clicks onto the proportions, the proportions being factored for risk, to provide the advertisers with a cost per click for the cost per click model.

In an embodiment, the real time sales comprise actual income obtained over a predetermined number of advertising placements.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. The data processor may include a volatile memory for storing instructions and/or data and/or a non-volatile storage, for example, a magnetic hard-disk, flash memory and/or removable media, for storing instructions and/or data. A network connection may be provided and a display and/or a user input device such as a keyboard or mouse may be available as necessary.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flow chart illustrating operation of an existing real time bidding system;

FIG. 2 is a simplified diagram illustrating network elements involved in the bidding system of FIG. 1;

FIG. 3 is a simplified diagram illustrating a modification of the procedure of FIG. 1 to accommodate actual sales of the advertiser related to the campaign in accordance with a first embodiment of the present invention;

FIG. 4 is a simplified diagram illustrating processes taking place at the advertiser side, according to embodiments of the present invention; and

FIG. 5 is a simplified diagram illustrating processes taking places at a bid assessment part of the system.

### DESCRIPTION OF SPECIFIC EMBODIMENTS OF THE INVENTION

The present invention, in some embodiments thereof, relates to advertising optimization for mobile telephones and the mobile environment in general.

While there are solutions in the market that enable the advertiser to dynamically bid for a click, an impression or a predefined event, there are no current models in the market that enable an advertiser to bid in real time a dynamic amount by automatically calculating the bid as a percentage of his actual earnings from advertising spend.

According to the present embodiments, a bidding system is located over a network between suppliers of advertising space in web content for mobile telephones on the one hand, and advertisers on the other hand, to supply advertising space with advertisements included therein to mobile phone users at content download time, bidding being carried out per content page per user download.

The bidding system operates by determining real time sales related to a given advertisement campaign; determining a proportion of those real time sales to be applied to the advertising space currently being downloaded; presenting the proportions as bids; selecting a best bid; and allowing the advertisement campaign corresponding to the selected bid to use the advertising space currently being downloaded.

The content holder or website publisher, as the supplier of the advertising space, need not see any change in the system. The successful bid can be divided by an expected number of clicks, so that the supplier is paid in the usual way.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

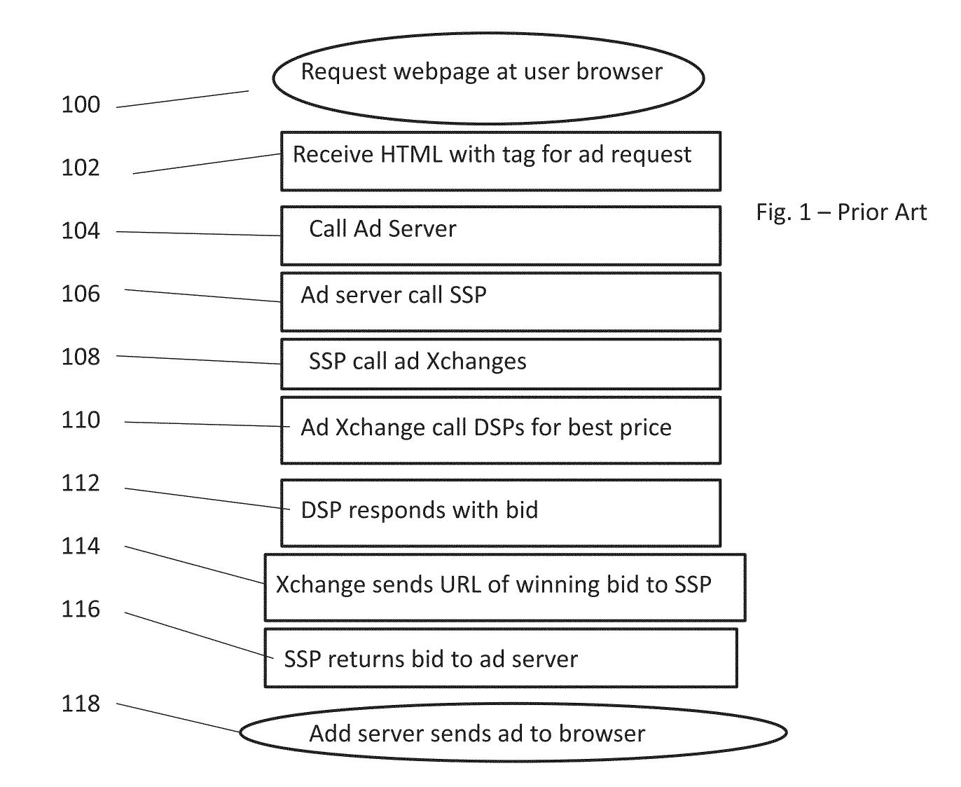

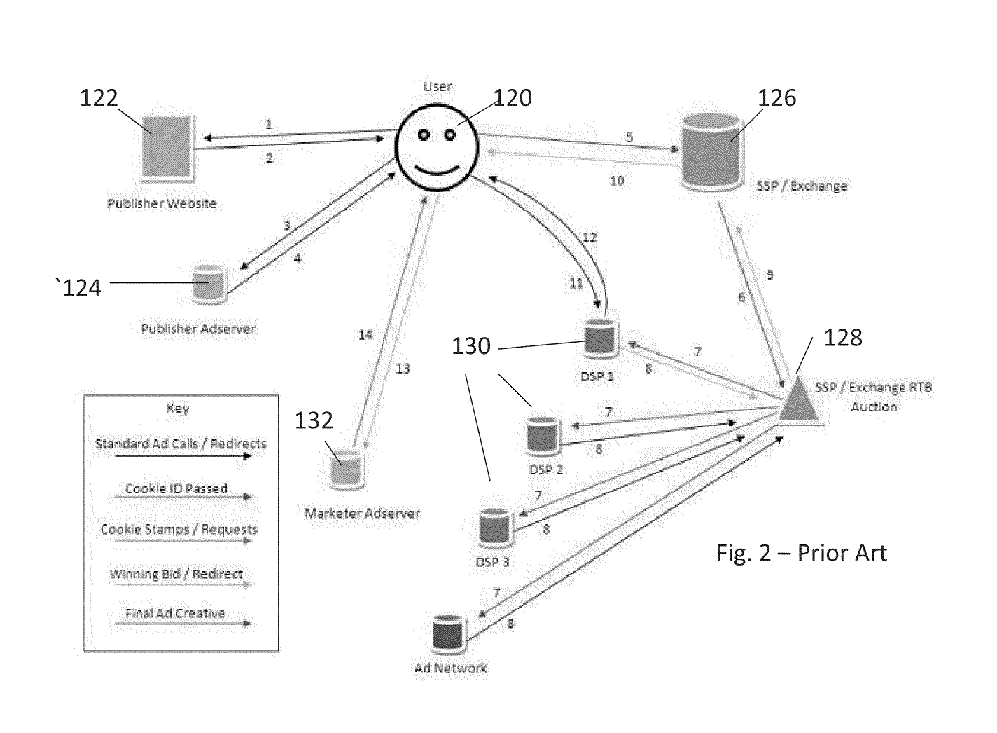

Referring now to the drawings, FIG. 1 shows a prior art real time bidding procedure for advertising spaces within content, and is discussed in detail below. FIG. 2 shows a network system for carrying out the method of FIG. 1, including advertiser and supplier side servers, and the same infrastructure is applicable to the embodiments of the present invention.

Referring to FIG. 2, a bidding system on a network mediates between suppliers of advertising space in web content for mobile telephones—web publisher 122, and advertisers who provide bids for advertising space via DSP servers 130. The publishers supply content to user 120 and the content has spaces for insertion of advertising. The publisher wishes to sell the advertising space to the highest bidder, and the real time bidding system takes bids for individual user downloads, to provide an advert for the specific space currently being downloaded by an individual user. Thus the bidding process is expected to take place and be completed in the time it takes to request and download a web page.

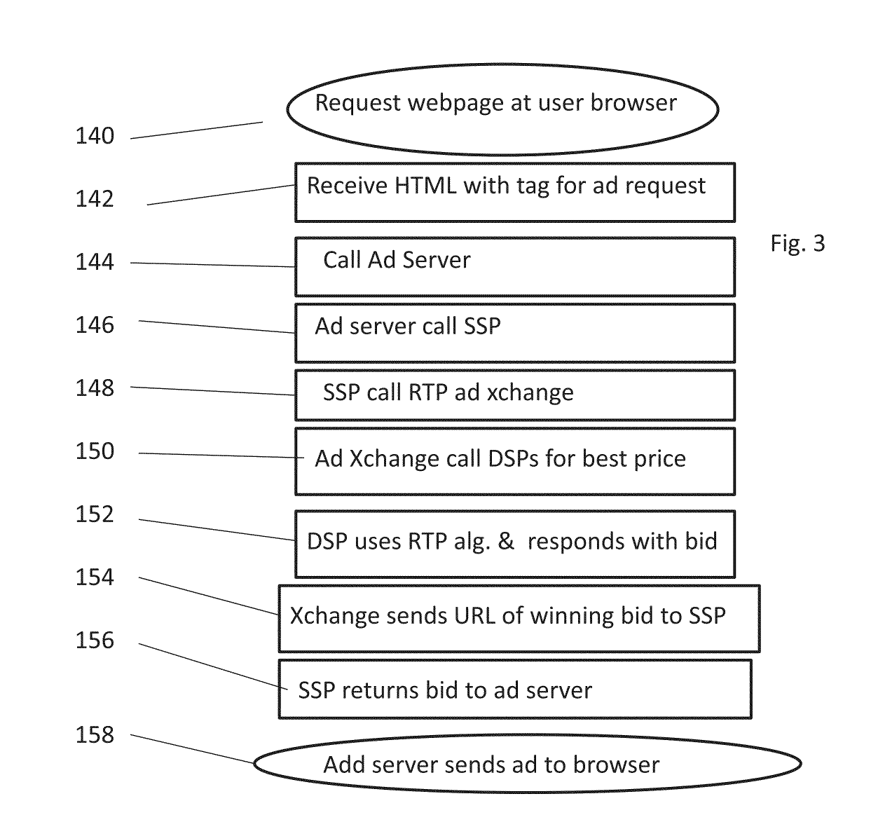

In accordance with the present embodiments the system electronically mediates a method as shown in FIGS. 3, 4 and 5.

FIG. 3 is a simplified flow chart contrasting the procedure of the present embodiments with the prior art procedure discussed in FIG. 1. FIG. 3 is discussed in greater detail hereinbelow.

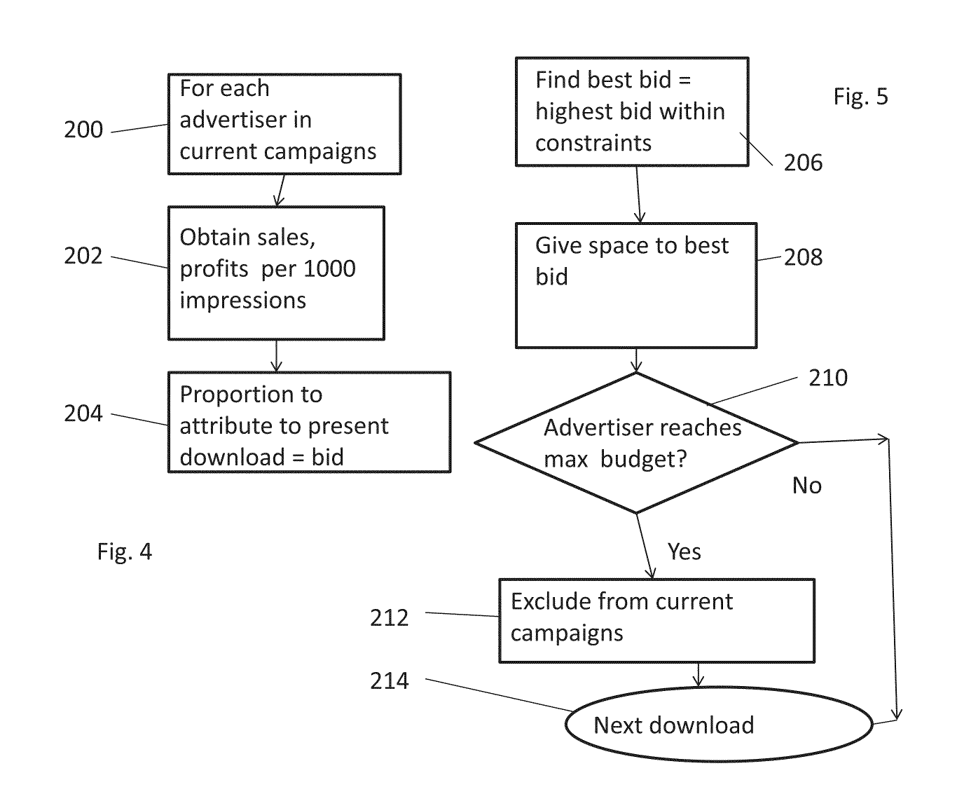

FIG. 4 is a simplified flow chart illustrating a procedure for an advertiser side of the system to set bids for individual advertisers based on actual sales values.

For each advertiser the method determines real time sales related to a given advertisement campaign—200. For example the system may keep tabs on recent clicks and have a figure of sales for the most recent thousand placed advertisements.

For each advertiser the system may determine a proportion of real time sales for the advertising space currently being downloaded—202. Thus if the advertiser knows he is making an average of $25 in sales per thousand advertisement placings, then the particular space is in principle able to provide a return on investment (ROI) of 25/1000=$0.25. In practice other factors may be added in. For example the user data of the current downloader may indicate that he/she is a sports fan, and sports fans are ten times more likely than average to respond to the campaign. Thus the current download may indicate a return on investment of $2.50. Clearly the advertiser wishes to make a profit on the placing and so will only be interested in providing a bid which is a proportion of the return on investment. As will be discussed in greater detail below, a significant amount of calculation may be used to differentiate between the indicated return on investment and the bid that is placed for the advertising space. Clearly the advertiser wishes to win the bid as long as the advertising space is not too expensive, and this encourages the advertiser to place a larger bid but not so large as to fail to give a return on his investment.

The system then presents the finally calculated proportion as a bid for the advertising space—204.

The system thus obtains multiple bids for the current advertising space.

Reference is now made to FIG. 5, which is a simplified flow chart illustrating the procedure for accepting bids and the immediate aftermath of accepting a bid.

The system has a set of constraints, which will be discussed in greater detail below, and the highest bid within those constraints is selected as a best bid—206. The highest bids are considered in order, although any bids not indicating a positive return on investment may be excluded.

The space in the content being downloaded to the end user is then filled with the advertisement from the campaign that provided the best bid—208.

One of the constraints that may be applied is a total budget constraint, through which each advertiser approves the maximum accumulated cost from total accepted bids he/she is willing to pay, typically in a predetermined time frame.

The total budget used by the system is typically less than a total budget approved by an advertiser, in order to provide a safety margin, as will be discussed in greater detail below.

The total budget may be dynamically adjusted, for example based on changes in real time sales. Thus if a campaign starts to fail, measured by a fall in the calculated return on investment, the particular advertiser automatically starts making smaller bids, but also the budget constraint comes into play, in particular if the advertiser starts making losses.

Once the advertiser's total cost in a predetermined time frame reaches the maximum budget, as per the advertiser's approval above, the particular advertiser is excluded from the group of current campaigns and ceases to actively bid. This in box 210 in the figure, after a particular advertiser successfully places an advert at a particular bid price, the cumulative amount owed by that advertiser is tested against a maximum budget set for the advertiser. If the maximum budget is reached or exceeded the advertiser is removed from the active pool of bidders in 212, and the system moves on to the next download in 214.

The method provides to the advertiser a cost per action model for placing advertisements but at the same time provides to the suppliers a cost per click model for selling their advertising space.

One way in which cost per action can be matched with cost per click is to factor a projected number of clicks for the advert onto the obtained proportion used for the bid. The proportions may be further factored for risk, and then the advertisers can be offered a cost per click even though the advertisers pay per action.

Thus the real time bids by the advertisers are based on actual income obtained over a predetermined number of advertising placements.

The invention and the background art are now considered in greater detail.

The present embodiments add to the three models discussed in the background a fourth model which may be referred to as a performance based advertising platform. Unlike current solutions the present embodiments may dynamically and automatically calculate the payment amount for the advertisers based on a real time or batch calculation of the advertisers actual income per sales, thus ensuring the advertisers profit on advertising spend. This payment amount may then be used to optimize advertisement insertion into inventory based on real time optimization of the publisher's income per thousand impressions to generate bids, the bids competing with other bids for clicks, impressions or fixed cost events. The calculation of the advertiser's real income or user lifetime value may consider many parameters including actual collection rates, customer churn rates, 3^{rd} party shares, billing success and any other parameter that can be reported by the advertiser to the system in real or near real time.

From the advertiser perspective the risk factor is the biggest deterrent for using the mobile ad network, which is notorious for its poor ROI. Thus, a new mobile model which is solely based on advertiser actual income may provide a new incentive for the advertiser to use a mobile ad network platform. In that case the risk shifts from the advertiser to the performance based ad platform and the publisher may continue to work with the generally risk free, cost per click—CPC model.

The following describes a way for the KP algorithm to work inside the risk boundaries defined by the platform business user while optimizing the revenues of the publishers.

A comparison to other models in the market is shown in Table 1.

TABLE 1
Comparison of current market practices for Real Time Bidding
(RTB).

| | | | | Network |
|---|---|---|---|---|
| | Performance | | | Aggregators |
| | Ad Platform | Ad Network | Affiliate Network | Exchanges |
| 99.9% fill rate from cross | ✓ | X | X | ✓ |
| network aggregation | | | | |
| CPA publisher share from ad | ✓ | X | ✓ | X |
| spend | 70% share | | 70% share | |
| CPC publisher share from ad | ✓ | ✓ | X | ✓ |
| spend | 70% share | 70% share | | 50% share |
| Real time empirical targeting | ✓ | X | X | X |
| based on actual consumer | | | | |
| purchases | | | | |
| Real time cross CPA/CPC | ✓ | X | X | X |
| business model optimization | | | | |

For example, an Internet user visits various sport websites. He arrives at a website (call it X) that uses Real-Time Bidding to deliver advertisements. In the background, an advertiser—a major beer distributor—has specified that they are interested in reaching sports enthusiasts. Several other advertisers also have expressed similar interests in sport enthusiasts. Before an ad is displayed all of these advertisers participate in a real time auction using their DSP (demand side platform) systems to supply bids to the ad exchange to which the SSP (supply side platform) system used by website X has floated the ad impression for sale. Whoever bids most wins the auction, and their ad gets displayed to the Internet user in question. In the present case, the beer distributor based on its proprietary data and 3rd party data about this specific Internet user decides to bid more for the present ad impression than other competing advertisers. The algorithms of the DSP that the present beer distributor uses predict a high probability of this internet user making a beer purchase and of a positive ROI on paying for this specific ad impression. Thus, the beer commercial wins the auction and gets displayed to the sports lover who visited website X.

To illustrate what happens in the background with RTB, reference is now made to FIG. 1, which is a simplified diagram showing the network transactions which typically take place from the technical point of view.

From the technical stand point the following typical transactions take place:
A user's browser requests a webpage of a publisher website that uses real time bidding,—100.
The user's browser receives the HTML for the webpage. Imbedded in this HTML is a URL tag for an ad request, 102.
The user's browser makes a call out to the ad server, 104.
The ad server sends a call out to the SSP that the website publisher website uses. Sometimes SSP and the ad server are integrated such as a 24/7 Real Media OpenAdstream system, 106.
SSP makes a call out to one or more ad exchanges, 108.
An ad exchange makes multiple call outs (bid requests) to several DSPs trying to get the best price, 110.
DSPs evaluate the bid request and decide how much they want to bid and respond with bids to the exchange, 112.
The exchange selects the highest bid with a URL of the winning advertisement and returns that to the SSP, 114.
SSP returns the winning bid to the ad server, 116.
The ad server finally responds with an advertisement to the browser of the Internet user, which started all these transactions, 118.

Reference is now made to FIG. 2, which is a schematic diagram showing the actors involved in the process of FIG. 1. The user browser 120 initially contacts the publisher website 122. The publisher ad server 124 receives the user browser's callout following receipt of the ad request tag. The SSP 126 receives the call out from the ad server 124. The Ad Exchange SSP 128 receives a call out from the ad server and sends out bid requests to multiple DSPs 130-1, 130-2, 130-3 etc. The ad server 132 finally responds by sending the advert which is the subject of the winning bid.

Buyers may thus acquire impressions they want at a price that matches their goals and objectives. For buyers, namely advertisers, real time bidding (RTB) offers the possibility of buying only the impressions they need at a price they are willing to pay by utilizing proprietary optimization algorithms of DSP systems and data from various 3rd party providers to fuel their algorithms.

Sellers may use SSP with supply side algorithms to get the maximum yield out of ad inventory which is available to them to sell. The supply side algorithms are focused on optimizing yield by manipulating floor prices.

RTB involves a real time auction for each ad impression in which buyers and sellers come to an agreement on the value of each ad impression, and are thus able to conclude the transaction.

The basic premise of RTB is that ad impressions are not commodities to be sold in bulk, and that each ad impression is unique—factors such as the time of day, the place or website, and the audience, and the propensity of that audience to make a purchasing transaction at that particular time and place and given their transaction history, can all have significant effect on the value of the placement.

Auctions take place in the blink of an eye, since the chosen advertisement has to be downloaded with the requested web page or other content. A typical exchange imposes one tenth of a second for the bids to return.

Volumes of bid requests and bids are also staggering. Google AdEx alone serves up 100 thousand bid requests a second.

The comparative example of FIGS. 1 and 2 suffers from various disadvantages, not least of which is the advertiser's reliance on DSP algorithms to decide what the impression is worth to him. True the advertiser may supply his own data to the algorithm, but the process happens automatically, and the advertiser is not protected from receiving a relatively high invoice at the end for a series of advertisement placements that have not been particularly effective.

The present embodiments seek to overcome the problem by specifically using the advertiser's real time sales as a return on investment component to the system.

Example of the Performance Based Real Time Platform (RTP)

In an example of the real time platform, an Internet user visits various sports websites. He arrives at a website (call it X) that uses Real-Time Bidding to deliver advertisements. In the background, an ROI driven advertiser—a major insurance company for example, has specified that they are interested in selling their insurance products on mobile devices. Several other advertisers have also expressed similar interests in selling their insurance products. Before an advertisement is displayed all of these advertisers participate in a real time performance auction using the RTP (Real time performance platform) system to supply revenue share-based offers to the ad exchange to which the SSP (supply side platform) system used by website X has floated this ad impression for sale. Unlike in a RTB system the advertiser is not bidding for clicks or impressions that might or might not convert into sales, instead the advertiser is bidding in real time a percentage of his actual sales generated by the inventory and advertisements inserted. Whoever bids most wins the auction, and their advertisement is displayed to the Internet user in question.

In the present case, the insurance advertiser may use his sales volume generated from his insurance products to the specific users to whom the advertisements are being inserted by the RTP, in this case sports users. Thus the insurer bids based on a higher revenue for the ad impression than other competing advertisers. The algorithms of the RTP predict a higher revenue share from the advertisers from the internet user purchasing insurance and at the same time may guarantee a positive ROI to the advertiser paying for this specific ad impression. There is thus provided a contrast with RTB systems which do not guarantee an ROI but only predict an ROI based on past historical usage and forecast income. Thus, the insurance advertiser commercial aimed at sports users wins the auction and gets displayed to the consumer who visited website X.

What Happens in the Background with RTP?

Reference is now made to FIG. 3, which is a simplified flow chart illustrating the process from the technical stand point. In FIG. 3 the following typical transactions take place:
A user's browser requests a webpage of a site that uses RTP—140.
The user's browser receives the HTML for the webpage. Imbedded in this HTML is a URL tag for an ad request—142.
The user's browser makes a call out to the ad server—144.
The ad server calls out the SSP that this website is using. Sometimes SSP and the ad server are integrated—146.
SSP makes a call out to one or more ad exchanges or ad networks including a performance based platform—148.
An ad exchange makes multiple call outs (bid requests) to several DSPs trying to get the best price—150.
DSPs evaluate the bid request based on actual historical sales events provided by the advertisers and calculate the actual revenue and based on the business configuration the actual revenue share from the advertisers sales to bid and respond with bids to the exchange, using the RTP Algorithm as discussed hereinbelow—152.
The exchange selects the highest bid with a URL of the winning ad and returns that to the SSP—154.
SSP returns the winning bid to the ad server—156.
The ad server finally responds with an ad to the browser which started the chain of transactions—158.

Buyers are thus able to acquire impressions they want at a price that is calculated as a percentage of their actual income and matches their goals and objectives. For buyers, RTP offers the possibility of buying only the impressions they need at a price they are willing to pay by paying only when actual sales are generated. By contrast, RTB lets buyers utilize proprietary optimization algorithms of DSP systems and data from various 3rd party providers to fuel their algorithms and predict potential income and ROI.

From the point of view of the sellers, namely the website providers who are selling the advertising space, the ad impression, the SSP uses supply side algorithms to get the maximum yield out of ad inventory which is available to them to sell. Unlike in RTB where the actual sales income from ad inventory is unknown, in RTP the actual sales events are tracked and used to give actual value to ad impressions. Thus the final values are not based on prediction but are based on actual sales. The supply side algorithms are focused on optimizing yield by manipulating floor prices.

RTB involves a real time auction for each ad impression in which buyers and sellers come to an agreement on the value of each ad impression to conclude the transaction.

The basic premise of RTP is that advertisers should only pay per actual sales and not for forecasted sales, so that ad impressions should be priced not as commodities to be sold in bulk but based on their actual generated sales volume. In both cases, auctions take place at the blink of an eye, as a web page is being loaded by the user. A typical exchange imposes a time limit of a tenth of a second for the bids to return.

The RTP Algorithm

The RTP platform aims to keep a positive ROI for the advertiser while optimizing the publisher revenues. For that purpose the platform uses a performance based real time bidding algorithm (see Chen et al 2011, Chen et al 2010). The algorithm is formulated as a constrained optimization problem that maximizes revenue subject to constraints. An embodiment may use the same model as Chen 2011 albeit modified to fit the cost per action (CPA) mobile model. The CPA mobile model, or cost per action, is an online advertising pricing model in which the advertiser pays for a specified action linked to the advertisement. While in the online world the constraints are the advertiser budget and the inventory availability, in the RPT framework the constraints are internal budgets that are set by the platform operators. In that sense the regular budget constraints are replaced by virtual budgets that are lower than or equal to the advertiser actual budgets (EBudget) and draw the maximal risk the platform is willing to take in a situation where the campaign fails.

Since the advertisers only pay publishers for performance-based metrics, i.e., conversions on their advertisements, the first step for the algorithm is to evaluate for each advertiser the expected revenue per impression according to the historical sales of the advertiser and the configurable share revenue parameter:

eCPI=CTR×CPA (1)

CPA=CTV×ASR×SP (2)

where CTR is the statistical evaluation of the Click through Rate (e.g., Li et al, 2009), CTV is the statistical evaluation of the actual conversion, ASR is the advertiser share revenue percentage with the publisher, CPA is the cost per specified action and SP is the sell price of the advertised product.

Theoretically, if the advertisers hold an unlimited budget and the platform does not issue any risk limitation for any of these advertisers, the revenue-optimal allocation mechanism is the trivial solution in which the platform assigns each impression to the campaign with the highest expected revenue per impression.

Nevertheless, it is known that such a solution is suboptimal under a constrained setting where demand-side constraints exist with a fixed advertising budget or a certain risk limit that is assigned by the ad platform. As in Chen et al 2009 and 2011, the bidding algorithm is based on the Linear Programming formulation in which we would like to optimize the ad fitting xᵢⱼ, where xᵢⱼ is the decision variable indicating whether impression i is assigned to campaign j (xᵢⱼ=1) or not (xij=0) (see table 2).

TABLE 2
The boolean matrix xij where the sum of row i is equal to 1
and the sum of the column j should be less than or equal to
the maximum risked budget the platform allows for advertiser j.

| | Campaign 1 | Campaign 2 | . . . | Campaign m |
|---|---|---|---|---|
| Ad | 1 | 0 | 0 | 0 |
| Impression 1 | | | | |
| Ad | 1 | 0 | 0 | 0 |
| Impression 2 | | | | |
| . | | | | |
| . | | | | |
| . | | | | |
| Ad | 0 | 1 | 0 | 0 |
| Impression | | | | |

We formulate the following:

$${max}_{x} {\sum }_{i , j}^{ } {eCPI}_{ij} {x}_{ij} \qquad ( 3 )$$

where the constraints are:

∀i,Σⱼxᵢⱼ≦1 (4)

which means that the advertisement slot may be assigned to only one campaign (see table 2).

∀j,Σᵢxᵢⱼ≦IBudgetⱼ (5)

which means that for each advertiser we require that the total Internal impression budget (IBudget) is below a certain risked budget which may later be dynamically changed according to the advertiser total ad performance. That is to say the platform may take on a higher risk for those advertisers that show a consistent positive ROI performance.

eCPIᵢⱼ is the expected eCPI for ad i in campaign j as predicted by the statistical algorithm given the advertiser historical sale prices and the share revenue parameter.

In contrast with all other Ad networks which are based on the online models (CPM, CPC) the RTP platform in the presently discussed embodiment provides a CPA model on the advertiser side while keeping the CPC model on the publisher side. As a result, the platform gains extra profit from all campaigns but also risks the loss of money in case of unsuccessful campaigns, and thus the platform may wish to manage the risk of negative ROI very carefully. For that purpose the platform may keep a “stop loss” budget (IBudget) for each advertiser and may continuously update the stoploss budget according to the actual performance of the advertiser's account.

The present embodiments may use the following formula to update the risked budget:

$$UpdateBudget ( {IBudget}_{j} , {P}_{j} ) = {IBudget}_{j} + \{ \begin{matrix}{P}_{j} \cdot {Q}_{1} & {P}_{j} > 0 \\ {P}_{j} \cdot {Q}_{2} & {P}_{j} \leq 0\end{matrix} \qquad ( 6 )$$

Where Pⱼ is the profit from campaign j (in case of loss the profit is of course negative). Q₁ is the factor that may be used to add to the risk in case of profit and Q₂ is the factor in case of losses (normally Q₁>Q₂).

Algorithm's Input

1. eCPIⱼ: the eCPI of campaign j is calculated by using the CPA model (see equation 1).

2. EBudgetⱼ: External Budget of campaign j.

3. IBudget; Internal Budget of campaign j.

3. alpha αj: The α j is initialized as the dual optimal solved from historical data (see Chen et al 2010).

```
RTP algorithm
BEGIN
  L ← φ
  For each impression i do
    j* ← arg max _{j∉L} (eCPIⱼ − αⱼ(t))
    IF (eCPIⱼ − a_{j*} > 0) THEN
      x_{ij*} ← 1
      xᵢⱼ ← 0, ∀j ≠ j*
      IF Σ_{i′}x_{i′j*} >= MIN(EBudget, IBudget) THEN
        L ← L∪ j*
      END
    END
    ELSE bid from External AdNetworks
    IBudgetⱼ ← UpdateIBudget(IBudgetⱼ , Pⱼ) ; (See equation 6)
    ${α}_{j} ( t + 1 ) ← {α}_{j} ( t ) exp ( λ ( \frac{{x}_{j} ( t )}{min ( EBudget , IBudget )} - \frac{1}{T} ) )$
  END
```

### DESCRIPTION

The algorithm gets as an input the following two historical data parameters:

(1) the Campaign Profit (Pj); and

(2) Current Cost Per Impression eCPIⱼ.

The algorithm also receives for each campaign j the external Budget (EBudget) and the internal budget (IBudget). αⱼ and βᵢ are calculated according to the offline process that appears in Chen 2011, the contents of which are hereby incorporated by reference.

In the offline problem, as it appears in equation (3) we require to maximize the total eCPM

$${max}_{x} {\sum }_{i , j}^{ } {eCPI}_{ij} {x}_{ij}$$

Given the 2 constraints (4) and (5). Thus, the dual problem of the offline problem becomes:

$$\begin{matrix}{min}_{α , β} {\sum }_{j}^{ } {g}_{j} {α}_{j} + {\sum }_{i}^{ } {β}_{i} \\ s . t . & ( 7 ) \\ ∀ i , j , \\ {α}_{j} + {β}_{i} > {v}_{ij} & ( 8 ) \\ {α}_{j} , {β}_{i} > 0 & ( 9 )\end{matrix}$$

In contrast to the Maximization problem above which needs to evaluate n×m variables (xᵢⱼ) in the dual problem we need to find only n+m variables αⱼ,βᵢ that minimize (7).

The time (t) is tracked in a discreet manner where tε[1 • • • T] such that t indexes sufficiently small time intervals and T is the number of intervals during the entire biding. The interval size is selected to capture the bid changes. If the size is too small then bid changes cannot be traced, and if the intervals are too large there will be too few intervals for the system to operate optimally.

For each coming impression i, the algorithm selects a campaign j* from the active campaigns list based on the highest bid. If the best bid reflects a positive ROI then the corresponding advertisement is placed. Then, the algorithm checks whether the total bids of the selected advertiser are below the internal budget. If the total bids exceed the allowed risked budget then the advertiser is removed from the active campaigns list. If there is no campaign with a positive ROI, then a bid is accepted for the impression from the external ad networks, with the aim of providing a 100% advertising fill rate.

The algorithm may then update the internal budgets of the advertisers according to their performance and update the αⱼ using the known water level controller formula. λ is the parameter which controls the speed of changes in the platform and xⱼ(t) denotes the number of times that campaign j wins during interval t.

It is expected that during the life of a patent maturing from this application many relevant pulse shaping and symbol decoding technologies will be developed and the scope of the corresponding terms in the present description are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### REFERENCES

(Chen & al, 2011) Ye Chen, Pavel Berkhin, Bo Anderson, and Nikhil R. Devanur. (2011). “Real-time Bidding Algorithms for Performance-based Display Ad Allocation.” In: Proceedings of the 17th ACM SIGKDD international conference on Knowledge discovery and data mining (KDD 2011) pages 1307-1315. doi: 10.1145/2020408.2020604.
(Wang & al, 2011) Click-Through Rate Estimation for Rare Events in Online Advertising (pages 1-12) Xuerui Wang (Yahoo! Labs, USA), Wei Li (Yahoo! Labs, USA), Ying Cui (Yahoo! Labs, USA), Ruofei Zhang (Yahoo! Labs, USA), Jianchang Mao (Yahoo! Labs, USA).

What is claimed is:

1. A bidding system on a network between suppliers of advertising space in web content for mobile telephones on the one hand, and advertisers on the other hand, to supply advertising space with advertisements included therein to mobile phone users at content download time, the advertising space to be supplied on a best bid basis at said content download time: the system electronically mediating a method as follows:
for each advertiser determining real time sales related to a given advertisement campaign;
for each advertiser determining a proportion of said real time sales to relate to said advertising space currently being downloaded;
presenting said proportions as bids by respective advertisers to allow their respective advertisement campaign to use said advertising space at said currently downloading mobile user;
selecting one of said bids as a best bid; and
allowing said advertisement campaign corresponding to said selected bid to use said advertising space at said currently downloading mobile user.

2. The method of claim 1, wherein said proportion is adjusted for available data of a currently downloading mobile user.

3. The method of claim 1, wherein said selecting of said best bid comprises applying a total budget constraint to each advertiser to limit a total number of bids won in a predetermined time frame.

4. The method of claim 3, wherein a total budget for said total budget constraint is less by a factor than a total budget indicated by a corresponding advertiser.

5. The method of claim 3, wherein a total budget for said total budget constraint is dynamically adjusted based on changes in said real time sales.

6. The method of claim 5, wherein, said selecting of said best bid comprises finding highest bids in order, and placing as said best bid the highest bid indicating a positive return on investment.

7. The method of claim 6, further comprising, after placing said bid, checking whether the total bids of the corresponding advertiser have reached the total budget constraint, and
if said total bids exceed said total budget constraint then removing said corresponding advertiser from an active campaigns list for participating in following bids.

8. The method of claim 1, comprising providing to the advertiser a cost per action model for placing advertisements and providing to said suppliers a cost per click model for selling advertising space.

9. The method of claim 8, comprising factoring a projected number of clicks onto said proportions, said proportions being factored for risk, to provide said advertisers with a cost per click for said cost per click model.

10. The method of claim 1, wherein said real time sales comprise actual income obtained over a predetermined number of advertising placements.
